(19) United States
(12) Patent Application Publication
(10) Pub. No.: US 2007/0231668 A1
(43) Pub. Date: Oct. 4, 2007

(54) FUEL CELL DEVICE

(76) Inventors: Tsang-Ming Chang, Taipei (TW); Wei-Li Huang, Taipei (TW); Chih Jung Kao, Taipei (TW); Yung Hua Lo, Taipei (TW); Chun-Wei Pan, Taipei (TW)

Correspondence Address: G.LINK CO., LTD, 3550 BELL ROAD, MINOOKA, IL, 60447, US

(21) Appl. No.: 11/690,118

(22) Filed: Mar. 22, 2007

(30) Foreign Application Priority Data
Apr. 4, 2006 (TW) 095205628

(51) Int. Cl. H01M 8/02; H01M 2/08

(52) U.S. Cl. 429/38; 429/36

(57) ABSTRACT

A fuel cell device is disclosed, which comprises one or more membrane electrode assemblies and at least one two-sided flow board disposed on one side of the membrane electrode assembly. The two-sided flow board comprises a substrate including one or more flow channels, wherein the flow channels are disposed corresponding to the membrane electrode assemblies. The two-sided flow board also comprises one or more conductive sheets made of a conductive material, wherein the conductive sheets respectively cover the flow channels of the substrate, and are fixed to the substrate. The two-sided flow board further comprises one or more current collection sheets made of a conductive material, wherein the current collection sheets respectively cover the conductive sheets, and are fixed to the conductive sheets.

### FIELD OF THE INVENTION

The present invention relates to a fuel cell, and more particularly, to a fuel cell device having a two-sided flow board.

### BACKGROUND OF THE INVENTION

A fuel cell is a power generator, which converts chemical energy stored within fuels and oxidants directly into electric energy through reactions with its electrodes. The kinds of fuel cells are diverse and their classifications are varied. According to the properties of proton exchange membranes thereof, fuel cells can be divided into five types including alkaline fuel cells, phosphoric acid fuel cells, proton exchange membrane fuel cells, fuse carbonate fuel cells, and solid oxide fuel cells.

Presently, materials for flow boards include graphite, aluminum and stainless steel, and usually utilize graphite. Flow channels fabricated on flow boards provide pathways for fuels and gases so that reactants can reach diffusion layers via flow channels and enter function layers for reactions. Additionally, flow boards are capable of conducting current, so the current from reactions can be further applied.

However, a conventional flow board (e.g. a graphite plate) may employs flow channels on two sides, which is large and heavy and has poor conductivity. Therefore, a traditional fuel cell stack made of such heavy two-sided flow boards is inevitably large and heavy. It is thus unfavorable to integrate fuel cell stacks with portable consumer electronic products. The overall ability to collect current needs to be enhanced as well.

### SUMMARY OF THE INVENTION

It is a primary object of the invention to provide a fuel cell device, in which the fuel cell itself is small and light, and the flow board collects current well.

In accordance with the aforementioned object of the invention, a fuel cell device is provided, which comprises one or more membrane electrode assemblies, each including an anode electrode, a proton exchange membrane and a cathode electrode, and at least one two-sided flow board disposed on one side of the membrane electrode assembly. The two-sided flow board comprises a substrate including one flow channels, wherein the flow channels are disposed corresponding to the membrane electrode assemblies. The two-sided flow board also comprises one or more conductive sheets made of a conductive material, wherein the conductive sheets respectively cover the flow channels of the substrate, and are fixed to the substrate. The two-sided flow board further comprises one or more current collection sheets made of a conductive material, wherein the current collection sheets respectively cover the conductive sheets, and are fixed to the conductive sheets.

### BRIEF DESCRIPTION OF THE DRAWINGS

The present invention will become more fully understood from the detailed description given hereinbelow illustration only, and thus are not limitative of the present invention, and wherein:

FIG. 1 is a perspective and associated diagram showing the essential portion of a fuel cell device according to one embodiment of the invention;

FIG. 2 is a perspective and associated diagram showing the essential portion of a fuel cell device according to another embodiment of the invention;

FIG. 3 is a perspective and associated diagram showing the essential portion of a fuel cell device according to yet another embodiment of the invention;

FIG. 4A is a perspective and exploded diagram showing a two-sided flow board for a fuel cell device according to one embodiment of the invention;

FIG. 4B illustrates the cross-section of the combined two-sided flow board in FIG. 4A;

FIG. 4C illustrates the cross-section of a modified embodiment of the two-sided flow board in FIG. 4B;

FIG. 4D illustrates the cross-section of a modified embodiment of the two-sided flow board in FIG. 4C; and

FIG. 5 is a perspective and exploded diagram showing the essential portion of a modified embodiment of the fuel cell device in FIG. 2.

### DETAILED DESCRIPTION OF THE INVENTION

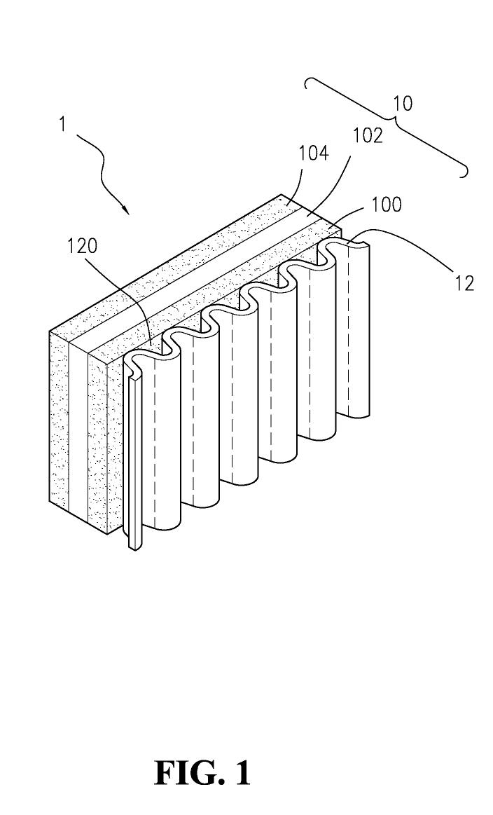

FIG. 1 is a perspective and associated diagram showing the essential portion of a fuel cell device according to one embodiment of the invention. Referring to FIG. 1, the fuel cell device 1 of the embodiment is a single fuel cell comprising a membrane electrode assembly (MEA) 10 and a two-sided flow board 12. The MEA 10 includes an anode electrode 100, a proton exchange membrane 102 and a cathode electrode 104. The two-sided flow board 12 is disposed on one side of the MEA 10. As shown in FIG. 1, each side of the two-sided flow board 12 consists of a plurality of trenches 120 arranged in parallel and spaced at intervals. Accordingly, the fuel cell device 1 generates power via a supply mechanism, by which fuels pass through the trenches 120 and electrochemically react with the MEA 10. Although the two-sided flow board 12 in FIG. 1 is in the form of a wavy structure, the two-sided flow board 12 may be composed of other zigzag structures with different geometric patterns, such as a trapezoid and/or a square and/or a semi-hexagon and/or a semicircle.

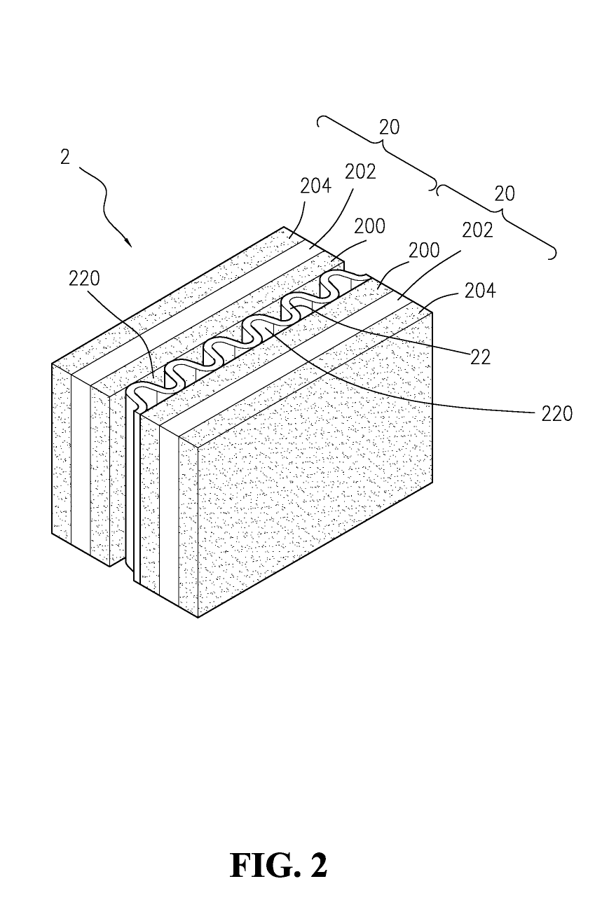

FIG. 2 is a perspective and associated diagram showing the essential portion of a fuel cell device according to another embodiment of the invention. Referring to FIG. 2, the fuel cell device 2 of the embodiment is a fuel cell stack comprising MEAs 20 and a two-sided flow board 22. The MEA 20 includes an anode electrode 200, a proton exchange membrane 202 and a cathode electrode 204. The two-sided flow board 22 is disposed on one side of the MEA 20, and particularly between the anode electrodes 200 of the MEAs 20. However, this configuration is not limited to disposing the two-sided flow board 22 between the anode electrodes 200 of the MEAs 20; also, various embodiments may be applied. For example, the two-sided flow board 22 may be disposed between the cathode electrodes 204 of the MEAs 20; alternatively, the two-sided flow board 22 may be disposed between the anode electrode 200 and the cathode electrode 204 of the MEAs 20. As shown in FIG. 2, each side of the two-sided flow board 22 consists of a plurality of trenches 220 arranged in parallel and spaced at intervals. Accordingly, the fuel cell device 2 generates power via a supply mechanism, by which fuels pass through the trenches 220 and electrochemically react with the MEAs 20. Though the two-sided flow board 22 in FIG. 2 is in the form of a wavy structure, the two-sided flow board 22 may be composed of other zigzag structures with different geometric patterns, such as a trapezoid and/or a square and/or a semi-hexagon and/or a semicircle.

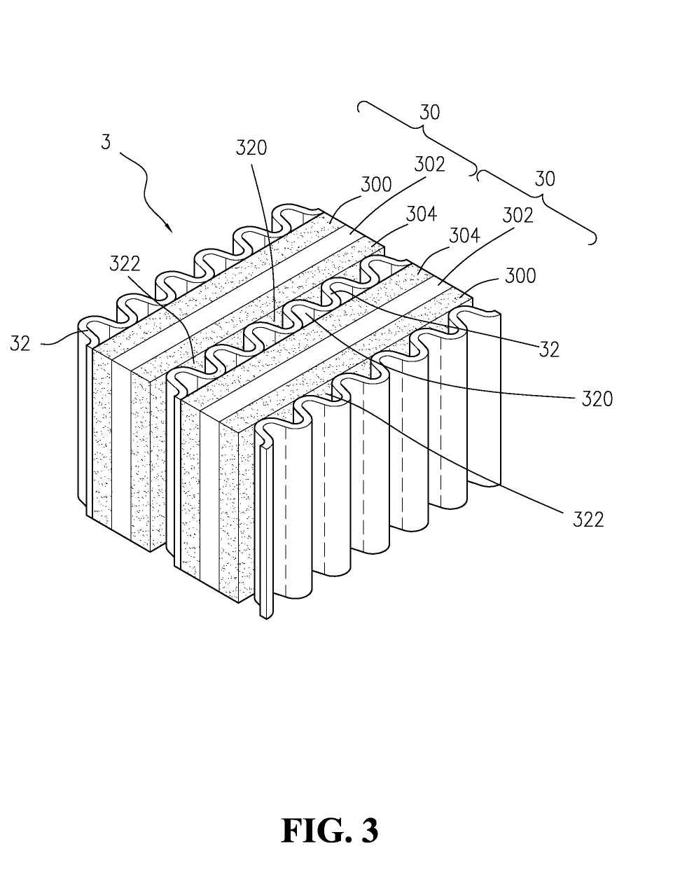

FIG. 3 is a perspective and associated diagram showing the essential portion of a fuel cell device according to still another embodiment of the invention. Referring to FIG. 3, the fuel cell device 3 of the embodiment is a fuel cell stack comprising MEAs 30 and two-sided flow boards 32. The MEA 30 is disposed between the two-sided flow boards 32, and includes an anode electrode 300, a proton exchange membrane 302 and a cathode electrode 304. As shown in FIG. 3, each side of the two-sided flow board 32 consists of a plurality of trenches 320 or trenches 322 arranged in parallel and spaced at intervals. Accordingly, the fuel cell device 3 generates power via a supply mechanism, by which fuels pass through the trenches 320 or trenches 322 and electrochemically react with the MEAs 30. Though the two-sided flow board 32 in FIG. 3 is in the form of a wavy structure, the two-sided flow board 32 may be composed of other zigzag structures with different geometric patterns, such as a trapezoid and/or a square and/or a semi-hexagon and/or a semicircle.

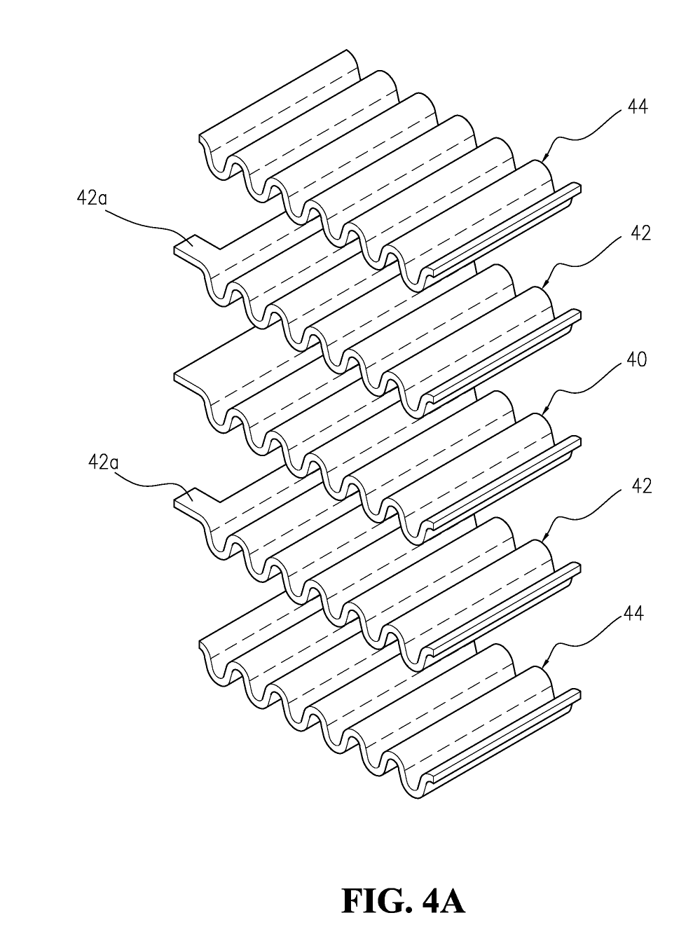

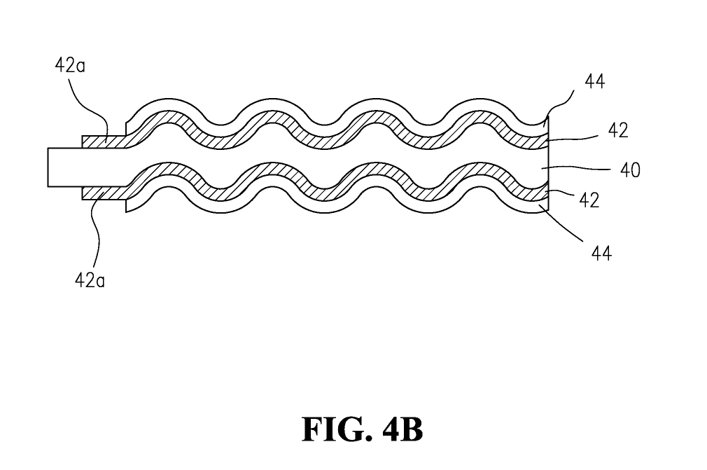

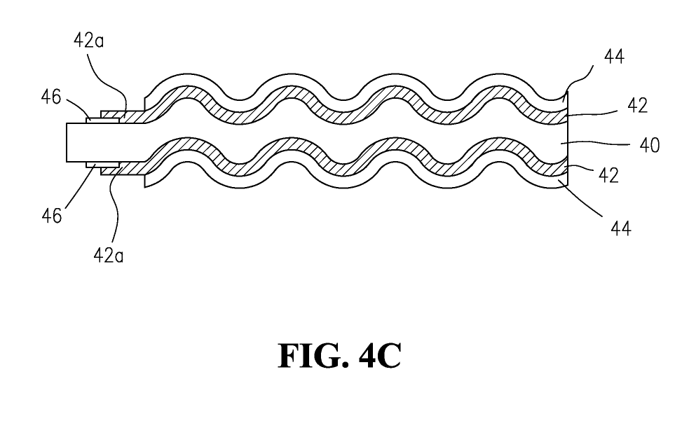

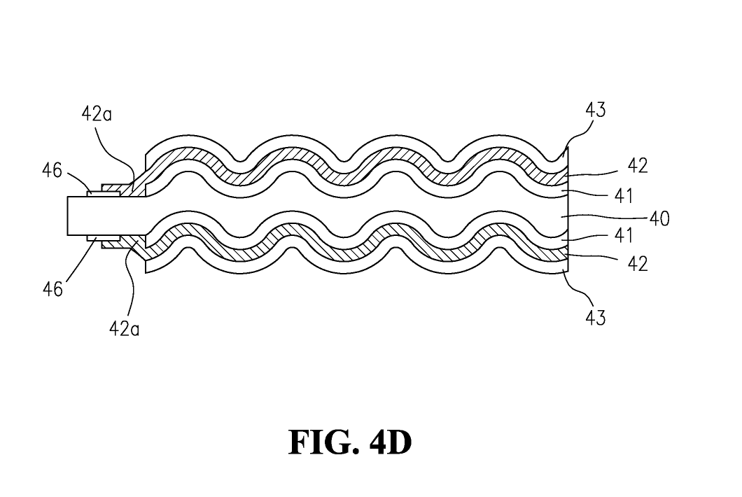

FIG. 4A is a perspective and exploded diagram showing the two-sided flow board 12, 22 or 32 for a fuel cell device according to the embodiments of the invention. FIG. 4B illustrates the cross-section of the combined two-sided flow board in FIG. 4A. Referring to FIG. 4A, the two-sided flow board 12, 22 or 32 comprises a substrate 40 including at least one flow structure, and the flow structures are disposed corresponding to the positions of the MEAs 10, 20, 30. The conductive sheets 42 made of conductive material respectively cover the flow structures of the substrate 40, and the conductive sheets 42 are fixed on the substrate 40. The current collection sheets 44 made of conductive material respectively cover the conductive sheets 42, and the current collection sheets 44 are fixed on the conductive sheets 42. In one embodiment, the conductive sheets 42 may be sealed onto the current collection sheets 44 by point welding, and then the conductive sheets 42 and the current collection sheets 44 are compressed and sealed onto the substrate 40 using a thermo-compressor with Prepreg resin films or anticorrosive and/or acid-proof adhesives (e.g. AB glue). Alternatively, the conductive sheets 42 may be attached with Prepreg resin films first and sealed to the current collection sheets 44. Alternatively, chemical-resistant non-metal or metal is coated by anticorrosive and/or acid-proof adhesives such as AB glue, and then sealed to the current collection sheets 44. As a result, a protective layer that is chemical-resistant is formed over the conductive sheet 42. As illustrated in FIG. 4A, the conductive sheet 42 also includes an extending portion 42a for electrically coupling to an external circuit.

Referring to FIG. 4C, which is the cross-section of a modified embodiment of the two-sided flow board in FIG. 4B, one or more circuit components 46 are further disposed on the substrate 40. The circuit component 46 may be a circuitry, and particularly a printed circuitry. As shown in FIG. 4C, the circuit component 46 is electrically connected with the extending portion 42a of the conductive sheet 42. As for the selection of material, the substrate 40 may adopt a substrate, such as a chemical-resistant and non-conductive engineering plastic substrate, a plastic carbon substrate, an FR4 substrate, an FR5 substrate, an epoxy resin substrate, a glass fiber substrate, a ceramic substrate, a polymeric plastic substrate, or a composite substrate. The material of the conductive sheet 42 may be selected from a group consisting of gold, copper, silver, carbon and well-conductive metal. The material of the current collection sheet 44 may utilize a well-conductive material, and the surface thereof is treated to be anticorrosive and/or acid-proof, or includes chemical-resistant metal (for example, stainless steel, titanium, gold, graphite, carbon-metal compound, etc.).

FIG. 4D illustrates the cross-section of a modified embodiment of the two-sided flow board in FIG. 4C. As shown in FIG. 4D, the two-sided flow board 12, 22 or 32 comprises a substrate 40 including at least one flow structure, and the flow structures are disposed corresponding to the positions of the MEAs 10, 20, 30. The first current collection sheets 41 made of conductive material respectively cover the flow structures of the substrate 40, and the first current collection sheets 41 are fixed on the substrate 40. The conductive sheets 42 made of conductive material separately cover the first current collection sheets 41, and the conductive sheets 42 are fixed on the first current collection sheets 41. The second current collection sheets 43 made of conductive material respectively cover the conductive sheets 42, and the second current collection sheets 43 are fixed on the conductive sheets 42. In one embodiment, the conductive sheet 42 is compactly sandwiched between the first and second current collection sheets 41, 43 by point welding. Alternatively, parts of the first and second current collection sheets 41, 43 as well as the conductive sheet 42 are connected by point welding, and the edges thereof are sealed together using adhesion or argon welding, so as to form a one-piece element, which is compressed and sealed to the substrate 40 thereafter. Additionally, as illustrated in FIG. 4D, the conductive sheet 42 includes an extending portion 42a for electrically coupling to the circuit component 46 of the substrate 40.

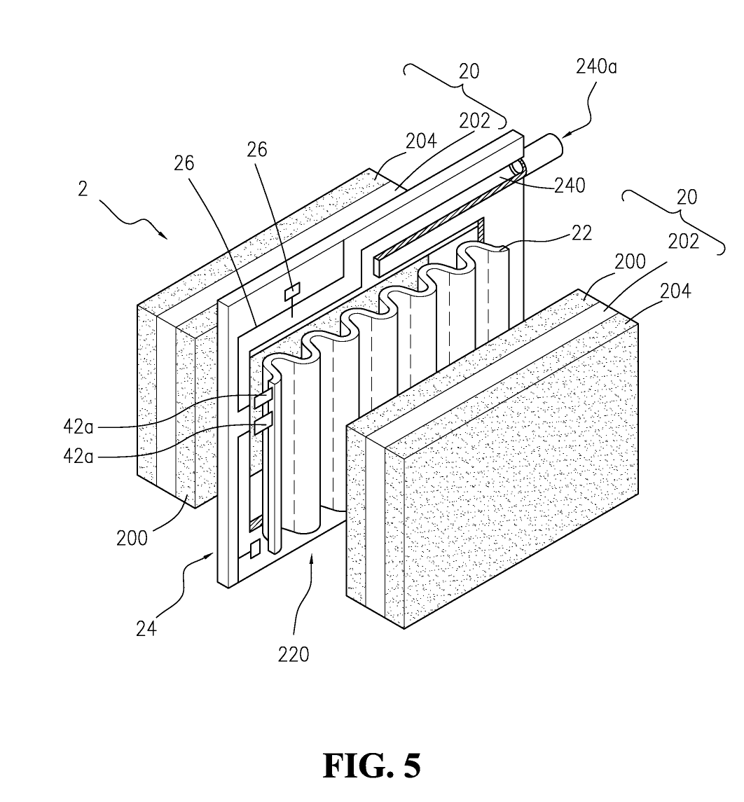

FIG. 5 is a perspective and exploded diagram showing the essential portion of a modified embodiment of the fuel cell device in FIG. 2. As shown in FIG. 5, the fuel cell device 2 further comprises a substrate 24 including one or more hollow portions. The hollow portions are disposed corresponding to the positions of the MEAs 20 such that the MEAs 20 and the two-sided flow board 22 are compressed and sealed onto the substrate 24. Furthermore, at least one circuit component 26 is disposed on the substrate 24. The circuit component 26 may be a circuitry, and particularly a printed circuitry. The circuit component 26 is electrically connected to the conductive sheet 42 of the two-sided flow board 22 by contacting with the extending portion 42a of the conductive sheet 42. Hence, the current collection sheets 44 are electrically connected as a serial and/or parallel circuit through the circuitry, so as to link every power-generating unit in a fuel cell stack. The mechanism of supplying fuels for the fuel cell device 2 is carried out via trenches 240 on the substrate 24. First, fuels are injected into an inlet 240a, and pass along the trenches 240. Then, fuels flow into the trenches 220, and electrochemically react with the MEAs 20 to generate power.

The fuel cell device of the invention may be, for example, a fuel cell with liquid fuels (e.g. methanol), a fuel cell with gaseous fuels, or a fuel cell with solid fuels. The features and efficacy of the invention are summarized as follows:

1. The fuel cell device of the invention uses a two-sided flow board with a geometric structure, so the entire volume and weight of a fuel cell (especially a fuel cell stack) are greatly reduced, which benefits the integration of fuel cells with portable consumer electronic products;

### 2. Because the two-sided flow board for a fuel cell device is rigid, the thickness of current collection sheets can be minimized, thus greatly decreasing the volume and weight of a fuel cell;

3. The two-sided flow board for a fuel cell device includes a substrate made from chemical-resistant and non-conductive material of engineering plastic, as well as current collection sheets made of conductive material. Hence, the fuel cell made thereby is light and portable, and the two-sided flow board is well-conductive; and
4. The two-sided flow board for a fuel cell device effectively prevents fuels (e.g. methanol) or products produced during electrochemical reactions from damaging the surfaces of the current collection sheets. Consequently, the replacement rate for fuel cells is lowered.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A fuel cell device, comprising:
at least one membrane electrode assembly disposed between a plurality of two-sided flow boards, wherein each membrane electrode assembly comprises an anode electrode, a proton exchange membrane and a cathode electrode; and
said two-sided flow boards, wherein each two-sided flow board comprises:
a substrate made of a non-conductive material, which includes one or more flow channels, wherein the flow channels are disposed corresponding to the membrane electrode assemblies;
one or more conductive sheets made of a conductive material, wherein the conductive sheets respectively cover the flow channels of the substrate, and the conductive sheets are fixed to the substrate; and
one or more current collection sheets made of a conductive material, wherein the current collection sheets respectively cover the conductive sheets, and the current collection sheets are fixed to the conductive sheets.

2. The fuel cell device of claim 1, wherein the current collection sheets are sealed to the conductive sheets by point welding.

3. The fuel cell device of claim 2, wherein a combination of the current collection sheets and the conductive sheets is compressed and sealed to the substrate by using an adhesive.

4. The fuel cell device of claim 3, wherein the adhesive is a Prepreg resin film.

5. The fuel cell device of claim 3, wherein the adhesive is an anticorrosive and/or acid-proof adhesive.

6. The fuel cell device of claim 5, wherein the adhesive is AB glue.

7. The fuel cell device of claim 1, wherein a substrate of the substrate is selected from a group consisting of a chemical-resistant and non-conductive engineering plastic substrate, a plastic carbon substrate, an FR4 substrate, an FR5 substrate, an epoxy resin substrate, a glass fiber substrate, a ceramic substrate, a polymeric plastic substrate, and a composite substrate.

8. The fuel cell device of claim 1, wherein a material of the current collection sheets is selected from a group consisting of stainless steel, titanium, gold, graphite, carbon-metal compound, and chemical-resistant metal.

9. The fuel cell device of claim 1, wherein the current collection sheet is made of a conductive material, and a surface of the current collection sheet is treated to be anticorrosive and/or acid-proof.

10. The fuel cell device of claim 1, wherein the two-sided flow board further comprises at least one circuit component disposed on the substrate.

11. The fuel cell device of claim 1, further comprising:
a substrate including one or more hollow portions, wherein the hollow portions are disposed corresponding to the membrane electrode assemblies.

12. The fuel cell device of claim 11, further comprising at least one circuit component disposed on the substrate.

13. The fuel cell device of claim 1, wherein each side of the two-sided flow board is composed of a plurality of trenches arranged in parallel and spaced at intervals, so as to form a wavy structure.

14. The fuel cell device of claim 1, wherein each side of the two-sided flow board is composed of a plurality of trenches arranged in parallel and spaced at intervals, so as to form a zigzag structure with trapezoidal and/or square and/or semi-hexagonal and/or semicircular patterns.

15. A fuel cell device, comprising:
at least one membrane electrode assembly disposed between a plurality of two-sided flow boards, wherein each membrane electrode assembly comprises an anode electrode, a proton exchange membrane and a cathode electrode; and
said two-sided flow boards, wherein each two-sided flow board comprises:
a substrate made of a non-conductive material, which includes one or more flow channels, wherein the flow channels are disposed corresponding to the membrane electrode assemblies;
one or more first current collection sheets made of a conductive material, wherein the first current collection sheets respectively cover the flow channels of the substrate, and the first current collection sheets are fixed to the substrate;
one or more conductive sheets made of a conductive material, wherein the conductive sheets respectively cover the first current collection sheets, and the conductive sheets are fixed to the first current collection sheets; and
one or more second current collection sheets made of a conductive material, wherein the second current collection sheets respectively cover the conductive sheets, and the second current collection sheets are fixed to the conductive sheets.

16. The fuel cell device of claim 15, wherein the first and second current collection sheets and the conductive sheets are sealed together by point welding and/or adhering and/or argon welding.

17. The fuel cell device of claim 16, wherein a combination of the first and second current collection sheets and the conductive sheets is compressed and sealed to the substrate by using an adhesive.

18. The fuel cell device of claim 17, wherein the adhesive is a Prepreg resin film.

19. The fuel cell device of claim 17, wherein the adhesive is an anticorrosive and/or acid-proof adhesive.

20. The fuel cell device of claim 19, wherein the adhesive is AB glue.

21. The fuel cell device of claim 15, wherein a substrate of the substrate is selected from a group consisting of a chemical-resistant and non-conductive engineering plastic substrate, a plastic carbon substrate, an FR4 substrate, an FR5 substrate, an epoxy resin substrate, a glass fiber substrate, a ceramic substrate, a polymeric plastic substrate, and a composite substrate.

22. The fuel cell device of claim 15, wherein a material of the first and second current collection sheets is selected from a group consisting of stainless steel, titanium, gold, graphite, carbon-metal compound, and chemical-resistant metal.

23. The fuel cell device of claim 15, wherein the first and second current collection sheets are made of a conductive material, and surfaces of the first and second current collection sheets are treated to be anticorrosive and/or acid-proof.

24. The fuel cell device of claim 15, wherein the two-sided flow board further comprises at least one circuit component disposed on the substrate.

25. The fuel cell device of claim 15, further comprising:
a substrate including one or more hollow portions, wherein the hollow portions are disposed corresponding to the membrane electrode assemblies.

26. The fuel cell device of claim 25 further comprising at least one circuit component disposed on the substrate.

27. The fuel cell device of claim 15, wherein each side of the two-sided flow board is composed of a plurality of trenches arranged in parallel and spaced at intervals, so as to form a wavy structure.

28. The fuel cell device of claim 15, wherein each side of the two-sided flow board is composed of a plurality of trenches arranged in parallel and spaced at intervals, so as to form a zigzag structure with trapezoidal and/or square and/or semi-hexagonal and/or semicircular patterns.
